(19) United States
(12) Patent Application Publication
(10) Pub. No.: US 2025/0277987 A1
(43) Pub. Date: Sep. 4, 2025

(54) INVERSE DESIGNED POLARIZATION ROTATOR AND BEAM SPLITTER

(71) Applicant: X Development LLC, Mountain View, CA (US)

(72) Inventor: Yi-Kuei Ryan Wu, San Jose, CA (US)

(21) Appl. No.: 18/591,912

(22) Filed: Feb. 29, 2024

(51) Int. Cl. G02B 27/10; G02B 5/30

(52) U.S. Cl. CPC G02B 27/10; G02B 5/3025

(57) ABSTRACT

A polarization rotating and beam splitting photonic device includes a planar waveguide having an input port and output ports disposed in or on a multi-layer semiconductor stack and a polarization rotating and beam splitting components integrated into the planar waveguide. The polarization rotating component includes a first irregular pattern of at least two materials having different refractive indexes. The first irregular pattern is shaped to rotate at least a portion of an optical signal received via the input port from a transverse magnetic (TM) polarization to a transverse electric (TE) polarization. The beam splitting component includes a second irregular pattern shaped to split the optical signal between the output ports. The first and second irregularly shaped patterns are optically coupled and collectively shaped to receive input TE and TM signals multiplexed on the optical signal at the input port and generate output TE signals demultiplexed on the output ports.

### TECHNICAL FIELD

This disclosure relates generally to photonic devices, and in particular but not exclusively, relates to polarization rotators and beam splitters.

### BACKGROUND INFORMATION

Artificial intelligence (AI) and machine learning (ML) applications are expected to place high demands on the data bandwidth of future XPUs (e.g., central processing units, graphic processing units, tensor processing units, etc.). In fact, data bandwidth is expected to be the bottleneck for future XPU development. In particular, board-to-board and chip-to-chip interconnects will need to support ever increasing bandwidths. Optical interconnects promise to satisfy this increasing bandwidth need. However, despite the high bandwidth provided by optical interconnects, conventional designs suffer from low data bandwidth density (i.e., data bandwidth per unit area). To improve the data bandwidth density of optical interconnects, photonic integrated circuits need to be reduced in physical size.

A polarization beam splitter (PBS) is a fundamental building block for high-speed optical interconnects as they enable polarization multiplexing. A PBS is an optical filter that splits an incident beam into two separate beams of different polarizations. In the ideal scenario, these separate beams are fully polarized with orthogonal polarizations. In the context of guided light (e.g., optic fibers), the incident light may include transverse electric (TE) and transverse magnetic (TM) polarizations and in the context of single mode waveguides (e.g., single mode optic fibers), the light may include just the fundamental spatial modes TE0 and TM0 for the respective polarizations. The TE0 and TM0 signals can increase the bandwidth of guided light by encoding distinct data channels on the orthogonal polarization modes TE0 and TM0.

A polarization rotator and beam splitter (PRBS) is yet another important building block for high-speed optical interconnects. A PRBS operates to split the TE and TM polarization components of light received on a single physical port to separate physical ports while also converting the disparate polarization components to a common polarization (e.g., TE polarization). PRBS may be integrated into high bandwidth photonic transceivers that use the TE and TM polarizations as independent data channels.

Conventional PBS have physical sizes on the order of 100 um×8 um while PRBS are typically quite long ranging between 700 um to 1500 um in length. A PBS that is able to substantially reduce these physical dimensions while maintaining expected functional characteristics (e.g., polarization crosstalk & isolation, insertion/transmission loss, back reflection, etc.) will help satisfy the higher data bandwidth density demands expected from future XPU development. Similarly, a PRBS that is capable of achieving a desired performance profile while reducing its physical length can reduce the overall size of a pluggable optical sub-assembly (OSA) into which the PRBS is integrated. The size of these photonic devices is expect to be a limiting factor in future optical communication and computing platforms.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1A is a functional block diagram of a polarization rotator and beam splitter (PRBS), in accordance with an embodiment of the disclosure.

FIG. 1B illustrates a practical application of a PRBS in the receiver and transmitter components of a semiconductor photonic transceiver, in accordance with an embodiment of the disclosure.

FIG. 2A illustrates cross-sections of different types of planar waveguides into which a PRBS may be integrated, in accordance with embodiments of the disclosure.

FIG. 2B is a cross-sectional view of a PRBS that includes an inversed designed irregularly shaped pattern integrated into a planar waveguide, in accordance with an embodiment of the disclosure.

FIG. 2C is a cross-sectional view of a PRBS that includes an inversed designed irregularly shaped pattern integrated into a planar waveguide, in accordance with an embodiment of the disclosure.

FIG. 3A illustrates a PRBS having polarization rotating and beam splitting components integrated together in a common component with a single combined inversed designed pattern sharing a common overlapping area within a planar waveguide, in accordance with an embodiment of the disclosure.

FIG. 3B illustrates a first example irregular pattern capable of implementing both polarization rotating and beam splitting functions of a PRBS, in accordance with an embodiment of the disclosure.

FIG. 3C illustrates a second example irregular pattern capable of implementing both polarization rotating and beam splitting functions of a PRBS, in accordance with an embodiment of the disclosure.

FIG. 3D illustrates the multipath interferometry that guides and converts an input TM signal to an output TE signal on a first output port of the PRBS, in accordance with an embodiment of the disclosure.

FIG. 3E illustrates the asymmetrical power splitting that guides an input TE signal to an output TE signal on a second output port of the PRBS, in accordance with an embodiment of the disclosure.

FIG. 3F illustrates a third example irregular pattern capable of implementing both polarization rotating and beam splitting functions of a PRBS, in accordance with an embodiment of the disclosure.

FIG. 3G illustrates power density heat maps for the third example showing the TM to TE signal path and the TE to TE path, in accordance with an embodiment of the disclosure.

FIG. 4A illustrates a PRBS having distinct polarization beam splitting (PBS) and polarization rotating (PR) components both of which are integrated into a planar waveguide, in accordance with an embodiment of the disclosure.

FIG. 4B illustrates an irregularly shaped pattern for implementing a PBS component of a PRBS, in accordance with an embodiment of the disclosure.

FIGS. 4C and 4D illustrate a transverse electric (TE) path through the PBS component that directs a majority of the power of the input TE signal to an output port via asymmetrical power splitting, in accordance with an embodiment of the disclosure.

FIGS. 4E and 4F illustrate transverse magnetic (TM) paths through the PBS component that direct a majority of the power of a TM optical signal to an output port via multipath interferometry, in accordance with an embodiment of the disclosure.

FIG. 4G illustrates an irregularly shaped pattern for implementing a PR component of a PRBS, in accordance with an embodiment of the disclosure.

FIG. 5A illustrates a PRBS having distinct polarization rotating and beam splitting components that also leverage spatial mode conversions, in accordance with an embodiment of the disclosure.

FIG. 5B illustrates examples of fundamental and higher order spatial modes.

FIG. 6A illustrates an irregularly shaped pattern for implementing a mode converter that selectively rotates a TM0 signal to a TE1 signal, in accordance with an embodiment of the disclosure.

FIG. 6B illustrates an irregularly shaped pattern for implementing a mode splitter that splits spatial modes while also converting a higher order mode to a fundamental order mode, in accordance with an embodiment of the disclosure.

FIG. 7A illustrates a demonstrative simulated environment for simulating the operation of a PRBS under design, in accordance with an embodiment of the disclosure.

FIG. 7B illustrates an operational simulation of a PRBS, in accordance with an embodiment of the disclosure.

FIG. 7C illustrates an adjoint simulation (backpropagation) of a performance loss error through the simulated environment including the PRBS, in accordance with an embodiment of the disclosure.

FIG. 8A is a flow chart illustrating example time steps for operational and adjoint simulations used to inverse design a PRBS, in accordance with an embodiment of the disclosure.

FIG. 8B is a flow chart illustrating a relationship between an operational simulation and the adjoint simulation (backpropagation), in accordance with an embodiment of the disclosure.

### DETAILED DESCRIPTION

Embodiments of a system, apparatus, and method of operation for a polarization rotating and beam splitting (PRBS) photonic device are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A typical function for a PRBS is to split light including both transverse electric (TE) and transverse magnetic (TM) components, which is received on a common physical port, into two separate physical ports while also converting the TM polarization component into a TE polarization component. Conversion of the TM components into TE components is often desirable since photonic devices may operate differently on the different polarizations (e.g., due to birefringence or other polarization dependent photoelectric effects).

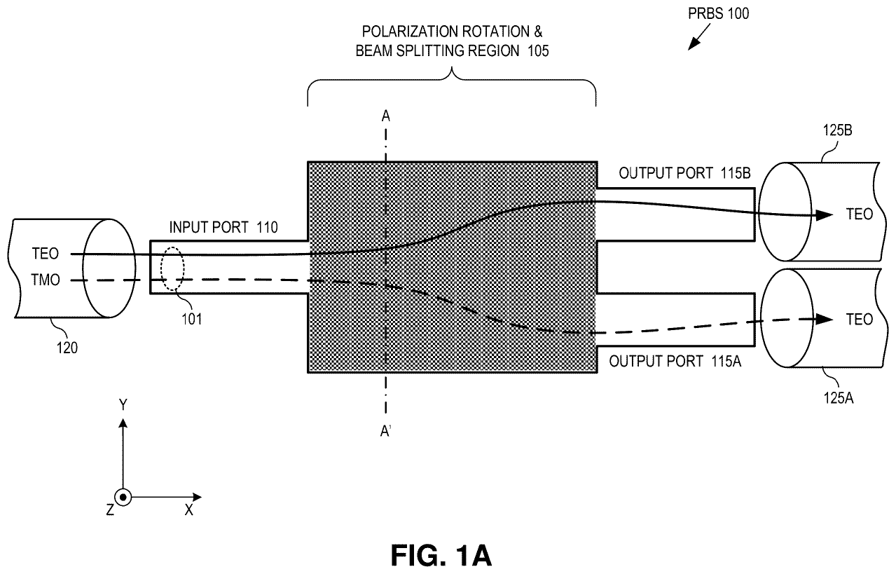

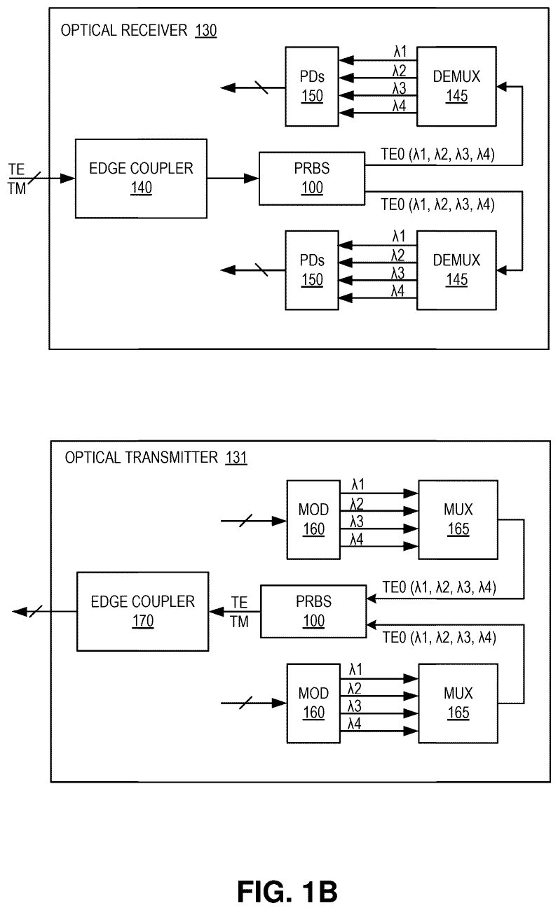

FIG. 1A illustrates a PRBS 100 in accordance with an embodiment of the disclosure. The illustrated embodiment of PRBS 100 includes a PRBS region 105, an input port 110, and output ports 115A and 115B (collectively 115). During operation, an optical signal 101 including TE components and TM components are received from a waveguide 120 (e.g., optic fiber) at input port 110. In the illustrated embodiment the TE and TM components are propagating in the fundamental spatial modes TE0 and TM0, which may be referred to as input TE and input TM signals, respectively. The input TE and TM signals may be independent (e.g., orthogonal) data channels multiplexed on a common carrier wavelength. Of course, waveguide 120 may guide multiple carrier wavelengths (referred to as dense wavelength division multiplexing or DWDM) each having independent TE and TM channels.

The PRBS region 105 operates to direct the input TE signal to the physical output port 115B for launching into waveguide 125B while both directing the input TM signal to output port 115A and converting its TM polarization to a TE polarization. In various embodiments described herein, PRBS region 105 is an irregularly shaped pattern of at least two materials having different refractive indexes integrated into a planar waveguide. The planar waveguide itself may be disposed in or on a multi-layer semiconductor stack and even be an integrated component of a photonic integrated circuit (PIC). For example, PRBS 100 may be implemented in a silicon PIC. In one embodiment, the irregularly shaped pattern is an inverse designed pattern. In some embodiments, the irregularly shaped pattern is a single component having a single combined pattern that implements both the polarization rotation and beam splitting functions. In yet other embodiments, the irregularly shaped pattern is separated into two distinct components each having distinct patterns that separately implement the polarization rotation and beam splitting functions. The irregularly shaped patterns may each be implemented as a single layer two-dimensional pattern (illustrated) or implemented as a three-dimensional pattern that extends across and is defined by multi-layers of a semiconductor stack up. Both single-layer and multi-layer patterns may be optimized using inverse design techniques such as those described herein.

PRBS are important components of silicon photonic optical transceiver modules that enable polarization multiplexing across optical links. FIG. 1B illustrates an example optical receiver 130 and optical transmitter 131 which each include an instance of PRBS 100. Optical receiver 130 and optical transmitter 131 may be integrated into a silicon photonic optical transceiver. As illustrated, optical receiver 130 includes an edge coupler 140 that receives, amplifies, and/or filters an input optical signal including data signals multiplexed on the TE and TM polarization. PRBS 100 demultiplexes the TE and TM polarizations to respective physical ports while also rotating the TM polarization to the TE polarization. The DWDM signals are then demultiplexed by DEMUXs 145 and converted from the optical to electrical realm by photodetectors 150.

Optical transmitter 131 operates in a reverse manner to optical receiver 130. In particular, electrical data signals are modulated by modulators 160, which in turn are multiplexed onto a common waveguide by MUXs 165. These WDMD optical signals are multiplexed onto the TE polarization and TE0 spatial mode. Each MUX 165 outputs its WDMD optical signal to a respective input port of PRBS 100. It is noteworthy that the principle of reciprocity in electromagnetism means PRBS 100 may be operated in reverse to multiplex TE0 optical signals received on distinct physical ports onto a single physical port using both the TE and TM polarizations. Finally, edge coupler 170 amplifies and/or filters the TE/TM multiplexed optical signal before launching the optical signal onto a transmission medium. Of course, edge couplers 140 and 170 may further implement various communication protocols related to the transmission medium.

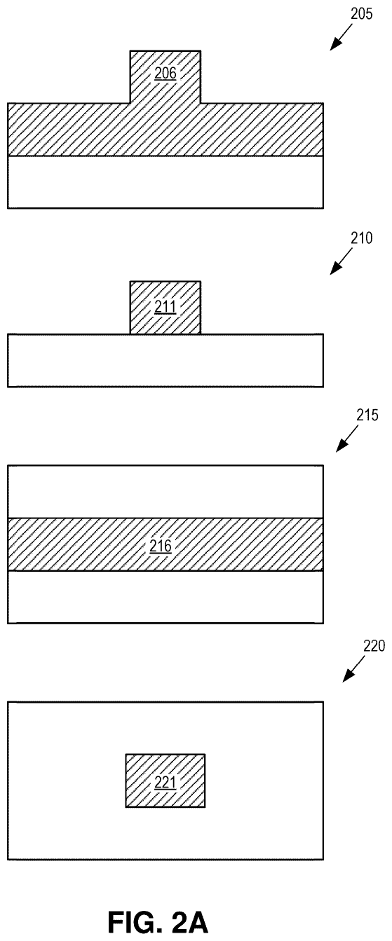

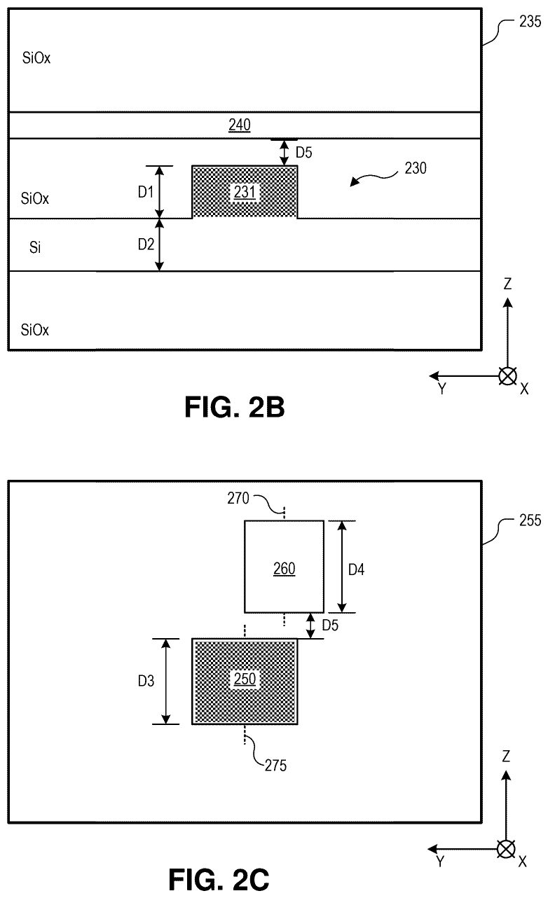

PRBS 100 may be integrated into a planar waveguide. FIG. 2A illustrates cross-sections of different types of planar waveguides, including a rib waveguide 205, a ridge waveguide 210, a slab waveguide 215, and a buried channel waveguide 220, in which PRBS 100 may be disposed. For example, PRBS 100 may be disposed within rib portion 206 of rib waveguide 205, ridge portion 211 of ridge waveguide 210, slab portion 216 of slab waveguide 215 or channel portion 221 of buried channel waveguide 220. FIGS. 2B and 2C illustrate specific examples corresponding to ridge waveguide 210 and buried channel waveguide 220.

Referring to FIG. 2B, PRBS 100 may be integrated into rib portion 231 of a rib waveguide 230 disposed within a multi-layer semiconductor stack 235. FIG. 2B is a cross-sectional illustration of multi-layer semiconductor stack 235. The cross-sectional view of FIG. 2B is aligned with cross-section A-A′ through PRBS region 105 in FIG. 1A. In one embodiment, multi-layer semiconductor stack 235 is a semiconductor-on-insulator stack including layers of silicon and silicon oxide while PRBS region 105 disposed within rib portion 231 is an irregular pattern of high and low refractive material (e.g., silicon and silicon oxide) fabricated into rib portion 231. Of course, stack 235 may include other materials and in FIG. 2B includes a material layer 240 disposed along the top side of rib waveguide 230. In one embodiment, material layer 240 is a passivation layer (e.g., 12 nm thick) of silicon nitride disposed approximately 5 nm above rib portion 231. In another embodiment, material layer 240 is polysilicon. Material layer 240 extends in the X-Y plane along at least a portion of PRBS region 105 that is responsible for rotation of the input TM signal to the TE polarization. Material layer 240 is a distinct material having a different refractive index than its surrounding material in multi-layer semiconductor stack 235 and helps encourage polarization rotation by breaking the symmetry of multi-layer semiconductor stack 235 in the vicinity of the planar waveguide (e.g., rib waveguide 230). In one exemplary embodiment, dimension D1 is 106 nm while dimension D2 is 55 nm. Of course, other dimensions are possible as well.

Referring to FIG. 2C, PRBS 100 may be integrated into buried channel waveguide 250 disposed within a multi-layer semiconductor stack 255. FIG. 2C is a cross-sectional illustration of multi-layer semiconductor stack 255. The cross-sectional view of FIG. 2C is aligned with cross-section A-A′ through PRBS region 105 in FIG. 1A. In one embodiment, multi-layer semiconductor stack 255 is a semiconductor stack including layers of silicon and silicon oxide while PRBS region 105 disposed within buried channel waveguide 250 is an irregular pattern of high and low refractive material (e.g., silicon and silicon oxide) fabricated into buried channel waveguide 250. Of course, stack 255 may include other materials and in FIG. 2C includes a material layer 260 disposed offset from buried channel waveguide 250. In one embodiment, material layer 260 is a distinct material from the material layers surrounding it or even distinct from the materials that form PRBS region 105. For example, in one embodiment, material layer 260 is silicon nitride. In another embodiment, material layer 260 is polysilicon. Material layer 260 extends in the X axis along at least a portion of PRBS region 105 that is responsible for rotation of the input TM signal to the TE polarization. Material layer 260 is a distinct material having a different refractive index than its surrounding material in multi-layer semiconductor stack 255 and helps encourage polarization rotation by breaking the symmetry of multi-layer semiconductor stack 255 in the vicinity of the planar waveguide (e.g., buried channel waveguide 250). In one embodiment, material layer 260 is disposed along just one side of buried channel waveguide 250 with its center 270 offset from the center 275 of buried channel waveguide 250. In one exemplary embodiment, dimension D3 is approximately 161 nm while dimension D4 is approximately 300 nm, and dimension D5 is 5 nm. Of course, other dimensions are possible as well.

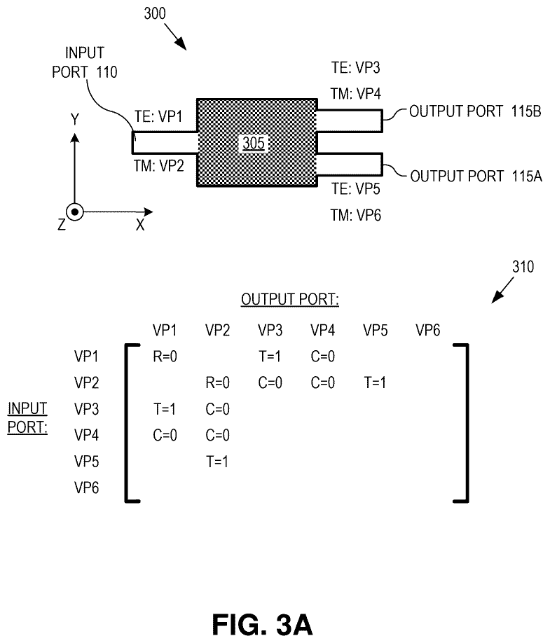

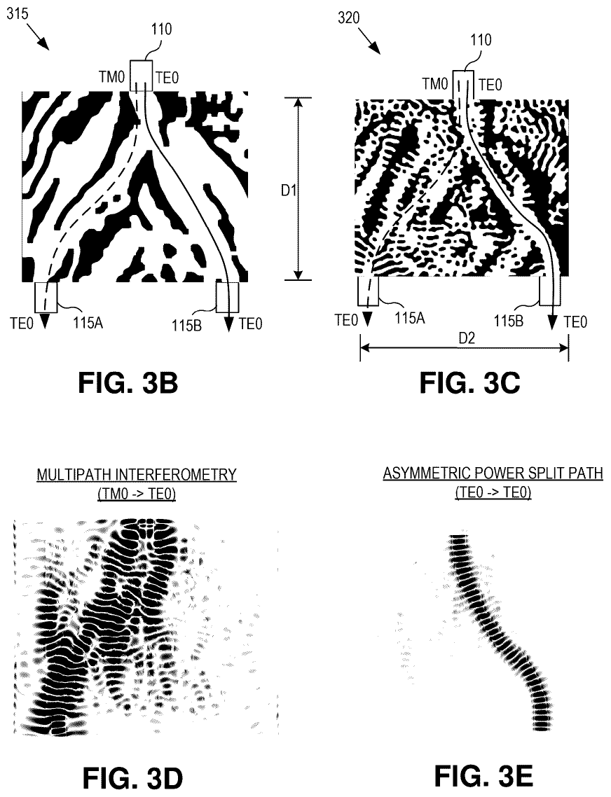

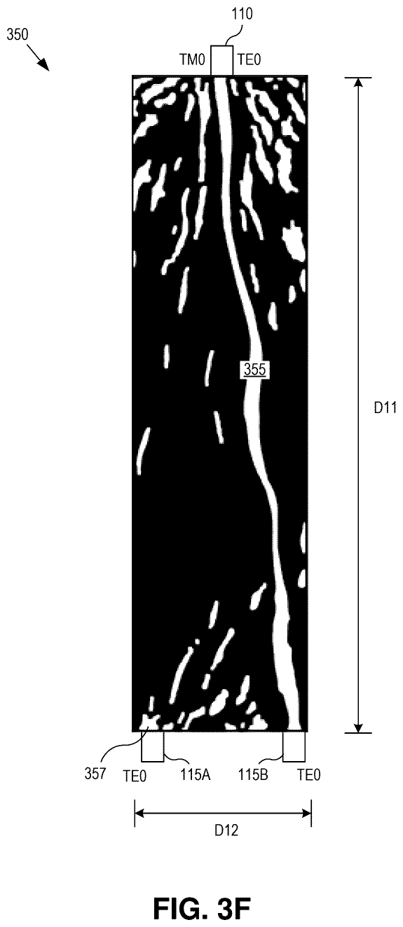

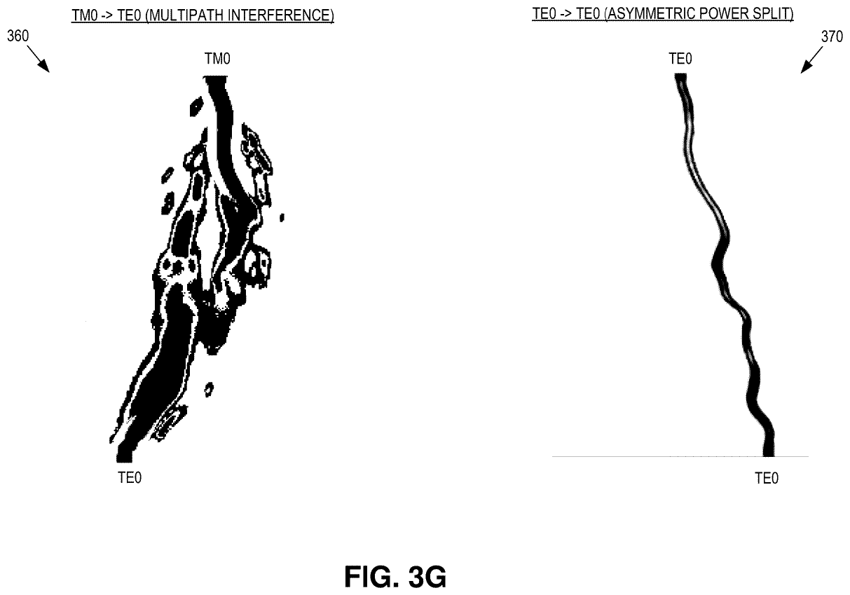

FIG. 3A is a functional block diagram illustrating a PRBS 300 having polarization rotating and beam splitting components integrated together in a common component, in accordance with an embodiment. PRBS 300 is one possible implementation of PRBS 100 illustrated in FIG. 1A. FIGS. 3B, 3C, and 3F illustrate specific implementations of inverse designed irregularly shaped patterns that form PRBS region 305 of PRBS 300. PRBS 300 achieves the polarization rotating and beam splitting functions with a single combined inverse designed pattern sharing a common overlapping area within any of the planar waveguides illustrated in FIGS. 2A-C.

In the illustrated embodiments, PRBS region 305 is a planar waveguide region having an irregularly shaped pattern disposed within the planar waveguide as a two-dimensional (2D) pattern. Of course, in other embodiments, a three-dimensional (3D) pattern may also be implemented where a multi-layer pattern is optimized via inverse design. In the illustrated embodiment, the 2D pattern is defined using two materials having distinct refractive indexes (e.g., silicon and silicon oxide). The pattern is an irregular pattern. For example, at the macro-level, the irregular pattern is not formed by regular geometric shapes such as triangles, rectangles, pentagons, hexagons, octagons, etc. Rather, the pattern is an organic pattern that resembles channels, inlets, and islands of a natural coastline. Of course, at the micro-level, the pattern may be formed by pixelated deposits of the two or more materials, which individual pixels may comprise a geometric shape. The feature size and shape of the individual material pixels is dependent upon the fabrication process, but the overall pattern does not resemble a simple, regular geometric shape such as a triangle, rectangle, or other low order polygon (e.g., 10 sides or less).

In one embodiment, PRBS 300 is inspired by inverse design. In particular, the pattern of at least two materials having differing refractive indexes may be defined by an iterative minimization of a loss function that sums a transmission loss, a reflection loss, and a crosstalk loss. The optimization objective of the inverse design methodology may be constructed as a function of the following loss function Loss(x),

$$Loss ( x ) = {\sum }_{λ} Transmission loss ( x , λ ) + {\sum }_{λ} Reflection loss ( x , λ ) + {\sum }_{λ} Crosstalk loss ( x , λ ) ,$$

$$where ,$$

$$Transmission loss ( x , λ ) = {( Transmission ( x , λ ) - target values 1 )}^{2}$$

$$Reflection loss ( x , λ ) = {( Reflection ( x , λ ) - target values 2 )}^{2}$$

$$Crosstalk loss ( x , λ ) = {( Crosstalk ( x , λ ) - target values 3 )}^{2} .$$

The objective is constructed in a way that the resulting structure/pattern of PRBS region 305 is encouraged to guide TE optical signals received at physical input port 110 to physical output port 115B while guiding TM optical signals received at physical input port 110 to physical output port 115A and rotate the TM polarization to a TE polarization.

FIG. 3A assigns virtual port (VP) labels to the TE and TM polarizations at each physical port. For example, input port 110 is assigned virtual ports VP1 and VP2 for the TE and TM polarizations, respectively. Similarly, virtual ports VP3 and VP4 are assigned to output port 115B for the TE and TM polarizations, respectively, and virtual ports VP5 and VP6 are assigned to output port 115A for the TE and TM polarizations, respectively. FIG. 3A further illustrates a scattering matrix (s-matrix) 310 having columns and rows corresponding to the virtual port labels. The behavior of PRBS region 305 may be described using the scattering-parameters (s-parameters) populated within s-matrix 310. S-matrix 310 may be referenced to populate the loss function Loss(x) used to design the PRBS region 305 using inverse design techniques. In particular, the s-parameters within s-matrix 310 represent the target values for transmission (T), reflection (R), and crosstalk (C). Blank spaces in the s-matrix 310 indicate “don't care” values that are not used as a target value in the loss function Loss(x).

Inverse design operates using a design simulator (aka design model) configured with an initial design or pattern for PRBS region 305 to perform a forward operational simulation of the initial design (e.g., using Maxwell's equations for electromagnetics). For example, the initial design could be a random pattern of silicon and silicon dioxide. The output of the forward operational simulation is a simulated field response at output ports 115 in response to stimuli at input port 110. Specific performance parameters of this output field response may be selected as parameters of interest (e.g., power loss, wavelength, crosstalk, etc.) and are referred to as simulated performance parameters. The simulated performance parameters are used by the loss function to calculate a performance loss value, which may be a scalar value (e.g., mean square difference between simulated performance values and target values). The differentiable nature of the design model enables a backpropagation via an adjoint simulation of a performance loss error, which is the difference between the simulated output values and the desired/target performance values. The performance loss error is backpropagated through the design model during the adjoint simulation to generate structural gradients that represent, for example, the sensitivity of the performance loss value to changes in the structural material properties (e.g., topology or pattern of materials) of PRBS region 305. A program such as TensorFlow published by Google may be used to calculate the gradients. These gradients may then be used by a structural optimizer to optimize or refine the initial structural design to generate a revised structural design of PRBS region 305. The forward and reverse simulations may then be iterated along with the structural optimization (e.g., iterative gradient descent, stochastic gradient descent, etc.) until the performance loss value falls within acceptable design criteria (referred to as saturation) and/or for a predetermined number of iterations. The above description is merely an example inverse design technique that may be used to refine or optimize the features and topology of the pattern within PRBS region 305. It is appreciated that other inverse design techniques alone, or in combination with other conventional design techniques, may also be implemented.

The inverse design techniques described above may be applied to determine the specific material combinations, feature sizes, and feature arrangement (i.e., irregular pattern) to achieve the desired polarization rotation and beam splitting using the above loss function. Loss(x) is a function of x, where x is a vector representing the structural pattern of materials having different refractive indexes within PRBS region 305.

FIG. 3B illustrates a first example irregular pattern 315 capable of implementing both polarization rotating and beam splitting functions of a PRBS, in accordance with an embodiment. Irregular pattern 315 is one possible implementation of PRBS region 305 (and 105). As mentioned, irregular pattern 315 is a single combined pattern that is integrated into a single common area of a planar waveguide. Irregular pattern 315 is an inverse designed pattern shaped to demultiplex the TE and TM signals received in input port 110 by directing a power majority of the TE0 signal to output port 115B via asymmetrical power splitting while directing a power majority of the TM0 signal to output port 115A via multipath interferometry. The inverse designed irregular pattern 315 may be fabricated from a patterned combination of silicon (being a higher refractive index material represented in white) and silicon oxide (being a lower refractive index material represented in black).

FIG. 3C illustrates another example inverse designed irregular pattern 320 that performs the same demultiplexing of the input TE and TM signals as described in connection with FIG. 3B. Irregular pattern 320 is yet another possible implementation of PRBS region 305 (and 105). FIG. 3D is a power density heat map illustrating the power density of the TM0 to TE0 multipath interferometry between input port 110 and output port 115A for irregular pattern 320. Similarly, FIG. 3E illustrates the power density of the TE0 to TE0 asymmetric power splitting path between input port 110 and output port 115B for irregular pattern 320. In one embodiment, irregular pattern 320 has approximate dimensions of D1=30 um and D2=7 um. Of course, other dimensions may be implemented as well. For example, D1 may range between 5-300 um and D2 may range between 2-40 um.

FIG. 3F illustrates yet another example inverse designed irregular pattern 350 that performs the same demultiplexing of the input TE and TM signals as described in connection with FIG. 3B while also rotating the TM polarization to the TE polarization. Irregular pattern 350 is yet another possible implementation of PRBS region 305 (and 105). Irregular pattern 350 includes a number of irregularly shaped features defined by the refractive materials. Many of these features may deviate from the illustrated pattern while achieving nearly similar efficient operation. However, some notable features include an irregularly shaped channel 355 of higher index material (e.g., silicon) extending continuously and circuitously from input port 110 to output port 115B. In contrast, it is also notable that the TM0 to TE0 path from input port 110 to output port 115A does not include a continuous uninterrupted channel of the higher index material extending between the two ports. Rather, output port 115A is connected to a small fjord-like feature 357 of the higher index material. Pattern 350 also includes a plurality of other irregularly shaped “islands” of the higher index material disposed within and throughout the lower index material (e.g., silicon oxide). These irregularly shaped islands are separate and distinct from irregularly shaped channel 355. The irregularly shaped islands are more densely dispersed proximate to the distal ends of irregular pattern 350 close to the ports while being more sparse in the middle region between the input and output ports. Pattern 350 is non-symmetrical along both orthogonal axes. In one embodiment, irregular pattern 350 has approximate dimensions of D11=30 um and D12=8 um. Of course, other dimensions may be implemented as well.

FIG. 3G includes a power density heat map 360 illustrating approximate power density of the TM0 to TE0 multipath interferometry between input port 110 and output port 115A for irregular pattern 350. FIG. 3G also illustrates a power density heat map 370 for the TE0 to TE0 asymmetric power splitting path between input port 110 and output port 115B for irregular pattern 350. As can be seen, a strong majority of the optical power in the input TM0 signal is directed towards the region coincident with output port 115A while a strong majority of the optical power in the input TE0 signal is directed towards the region coincident with output port 115B.

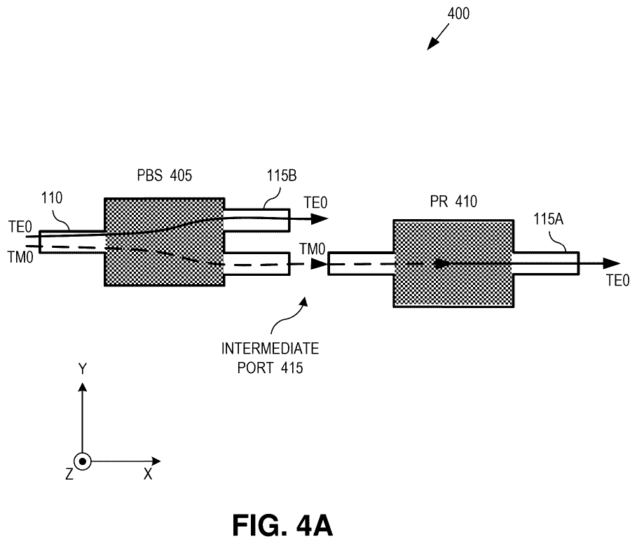

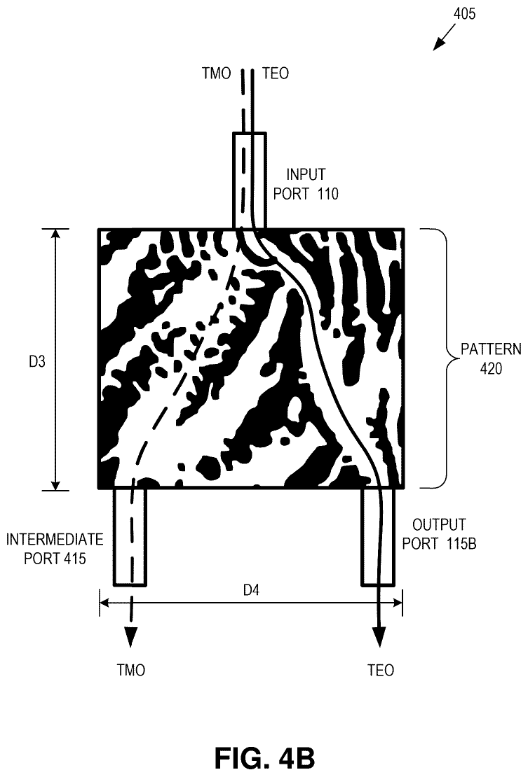

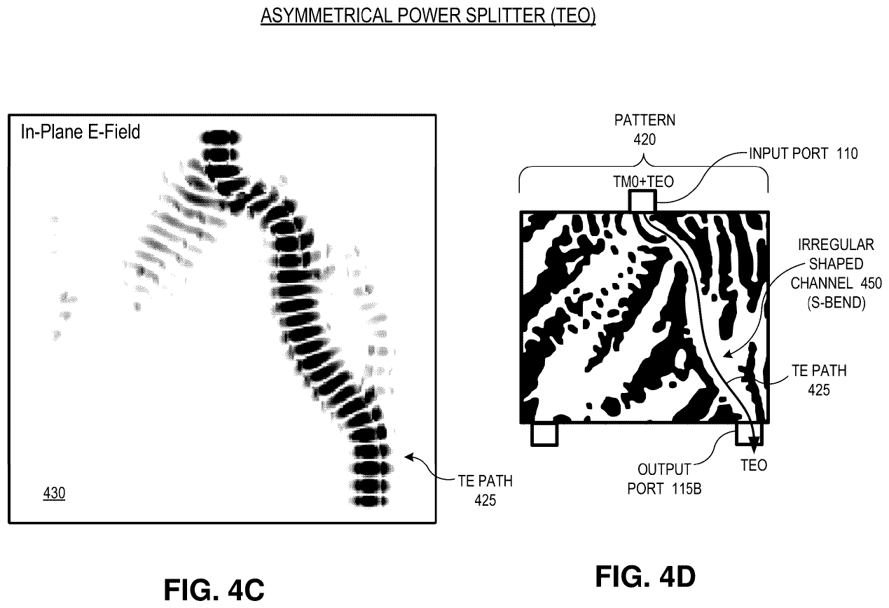

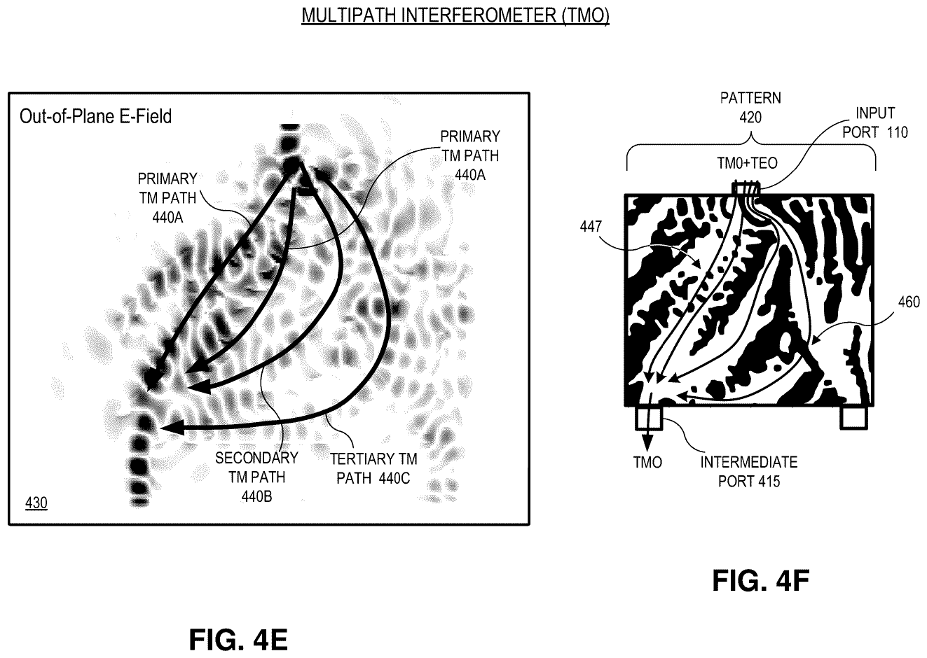

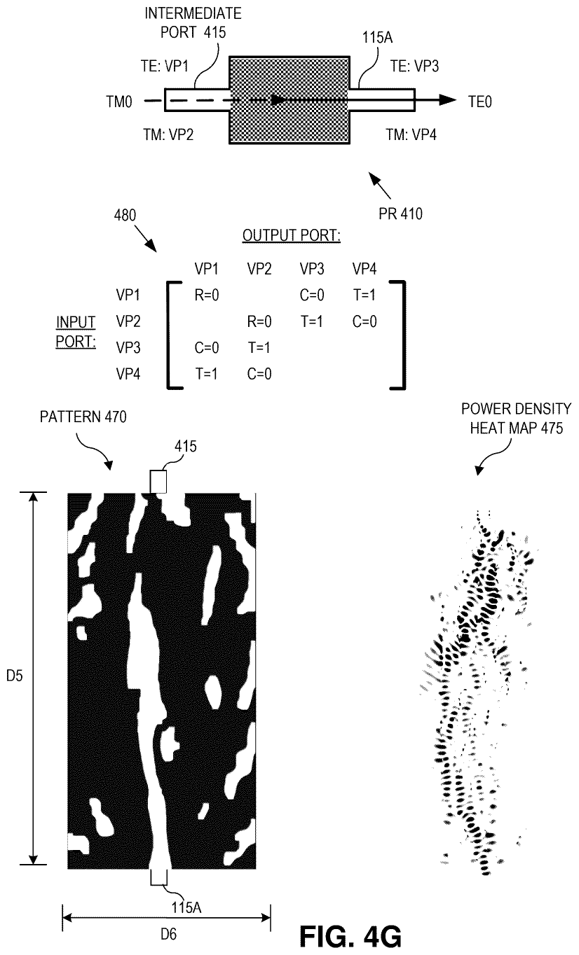

FIG. 4A is a functional block diagram illustrating a PRBS 400 having distinct polarization beam splitting (PBS) and polarization rotating (PR) components linked end-to-end, in accordance with an embodiment. PRBS 400 is one possible implementation of PRBS 100 illustrated in FIG. 1A. PRBS 400 includes a PBS 405 and PR 410 that collectively implement PRBS region 105 illustrated in FIG. 1A by linking PBS 405 and PR 410 end-to-end at an intermediate port 415. In one embodiment, PBS 405 and PR 410 are implemented by distinct irregularly shaped patterns that are both integrated end-to-end into a single common planar waveguide (or a pair of linked planar waveguides) by optically linking a TM0 output of PBS 405 to the input of PR 410. FIGS. 4B-4F illustrate a specific inverse designed irregularly shaped pattern that forms PBS 405 while FIG. 4G illustrates a specific inverse designed irregularly shaped pattern that forms PR 410.

Collectively, PBS 405 and PR 410 achieve the beam splitting and polarization rotation functions in two distinct patterns/components. PBS 405 beam splits the input TE and TM signals to output port 115B and intermediate port 415, respectively. PBS 405 directs a first power majority of the input TE signal to output port 115B via asymmetrical power splitting while directing a second power majority of the input TM signal to intermediate port 415 via multipath interferometry. PR 410 includes an input aligned with intermediate port 415 and its output is aligned to output port 115A. PR 410 operates to rotate the TM polarization to a TE polarization.

FIG. 4B illustrates an example inversely designed irregularly shaped pattern 420, in accordance with an embodiment of the disclosure. Pattern 420 is one possible inverse design implementation for PBS 405 illustrated in FIG. 4A. Pattern 420 is an irregular pattern of at least two materials (e.g., silicon and silicon dioxide) having different refractive indexes. Pattern 420 is shaped to demultiplex the TE optical signals (e.g., TE0) and the TM optical signals (e.g., TM0) received at input port 110. Pattern 420 is shaped to direct a majority of the power of the TE optical signal receive at input port 110 to output port 115B. The selective directing of the TE optical signal to output port 115B is achieved via an asymmetrical power splitting that sends a majority of the TE power to output port 115B. Correspondingly, pattern 420 is also shaped to direct a majority of the power of the TM optical signal received at input port 110 to intermediate port 415. The selective directing of the TM optical signal to intermediate port 415 is achieved via multipath interferometry that sends a majority of the TM power to intermediate port 415.

In one embodiment, pattern 420 is integrated into a planar waveguide having the illustrated pattern disposed within the planar waveguide as a two-dimensional (2D) pattern. Of course, in other embodiments, a three-dimensional (3D) pattern defined within multi-layers of a semiconductor stack up may also be implemented. In the illustrated embodiment, the 2D pattern is defined using two materials having distinct refractive indexes (e.g., silicon and silicon dioxide). Pattern 420 is an irregular pattern. For example, at the macro-level, the irregular pattern is not formed by regular geometric shapes such as triangles, rectangles, pentagons, hexagons, octagons, etc. Rather, pattern 420 is an organic pattern that resembles channels, inlets, and islands of a natural coastline. Of course, at the micro-level, the pattern may be formed by pixelated deposits of the two or more materials, which individual pixels may comprise a geometric shape. The feature size and shape of the individual material pixels is dependent upon the fabrication process, but the overall pattern does not resemble a simple, regular geometric shape such as a triangle, rectangle, or other low order polygon (e.g., 10 sides or less). In one embodiment, pattern 420 has approximate dimensions of D3=7 um and D4=8 um. Of course, other dimensions may be implemented as well.

In the illustrated embodiment, the irregular shaped pattern includes a number of pattern features (i.e., irregularly shaped features) that facilitate the asymmetrical power splitting of the TE optical signal along with the simultaneous multipath interferometry of the TM optical signal. FIGS. 4C, 4D, 4E, and 4F illustrate these pattern features. In particular, FIGS. 4C and 4D illustrate a TE path 425 through polarization splitting region 430 that directs a majority of the power of the TE optical signal to output port 115B via asymmetrical power splitting. Polarization splitting region 430 is the multi material region within a planar waveguide into which pattern 420 is integrated. Correspondingly, FIGS. 4E and 4F illustrate TM paths 440A-C through polarization splitting region 430 that direct a majority of the power of the TM optical signal to intermediate port 415 via multipath interferometry.

Referring to FIG. 4D, TE path 425 extends from input port 110 to output port 115B along an irregular shaped channel 450. Irregular shaped channel 450 is formed of the higher index material, such as silicon (illustrated as white), surrounded by the lower index material, such as silicon dioxide (illustrated as black). In the illustrated embodiment, irregular shaped channel 450 includes an S-bend shape that is not obstructed between input port 110 and output port 115B by the lower index material. In other words, the irregular shaped channel 450 forms a continuous, unobstructed, pathway that forms a mild circuitous S-bend shape between the ports. Irregular shaped channel 450 facilitates the asymmetrical power splitting that guides a majority of the optical power in the TE optical signal from input port 110 to output port 115B. FIG. 4C is a power density heat map illustrating the power density of the TE optical signal (in-plane E-field) through polarization splitting region 430. As illustrated, a strong majority of the optical power in the TE optical signal is guided along irregular shaped channel 450 along TE path 425 and reaches output port 115B.

Referring to FIGS. 4E and 4F, TM paths 440A-C (collectively referred to as TM paths 440) extend from input port 110 to intermediate port 415 along multiple interferometry paths. TM paths 440A-C are also defined by the higher index material, such as silicon (illustrated as white), surrounded by the lower index material, such as silicon dioxide (illustrated as black). The primary TM path 440A is composed of two sub-paths that weave around and through a number of scattering locations. In other words, primary TM path 440A includes a plurality of scattering location 447 formed from islands of lower index material disposed within the high index material. The secondary TM path 440B takes an unobstructed circuitous path through the higher index material. The tertiary TM path 440C takes an even less direct path through the higher index material (partially along irregular shaped channel 450) and is obstructed at location 460 by low index material. It is believed that evanescent coupling and/or the near normal incidence of tertiary TM path 440C to the low index material obstruction permits the components of the TM optical signal to pass through the lower index material obstruction at location 460. Regardless, the multiple TM paths established by pattern 420 between the input port 110 and intermediate port 415 direct a strong majority of the optical power in just the TM optical signal from input port 110 to intermediate port 415 via multipath interferometry. The power density heat map of FIG. 4E illustrates the strong coupling of the TM optical signal (out-of-plane E-field) to intermediate port 415.

FIG. 4G illustrates an irregularly shaped pattern 470 for implementing PR 410, in accordance with an embodiment. Pattern 470 is an inverse design irregularly shaped pattern that operates to rotate a TM signal received on intermediate port 415 to a TE signal output from output port 115A. Accordingly, PR 410 is coupled end-to-end with PBS 405 by having its input and output optical aligned with intermediate port 415 and output port 115A, respectively, to form PRBS 400. Pattern 470 includes a higher refractive index material (illustrated as white) surrounded by a lower refractive index material (illustrated as black). In the illustrated embodiment, pattern 470 does not include a continues uninterrupted channel of the higher refractive index material extending between its input and output ports. Pattern 470 is non-symmetrical along both orthogonal axes and includes irregularly shaped features defined by the refractive materials. In one embodiment, pattern 470 has approximate dimensions of D5=20 um and D6=7 um. Of course, other dimensions may be implemented as well. For example, D5 may range between 5-300 um and D6 may range between 2-40 um. Power density heat map 475 illustrates the internal power density while rotating the TM signal to the output TE signal.

FIG. 4G assigns virtual port (VP) labels to the TE and TM polarizations at each physical port. For example, intermediate port 415 is assigned virtual ports VP1 and VP2 for the TE and TM polarizations, respectively. Similarly, virtual ports VP3 and VP4 are assigned to output port 115A for the TE and TM polarizations, respectively. S-matrix 480 has columns and rows corresponding to these virtual port labels. The behavior of pattern 470 may be described using the s-parameters populated within s-matrix 480. S-matrix 480 may be referenced to populate the loss function Loss(x) (see above) used to design the pattern 470 using inverse design techniques. In particular, the s-parameters within s-matrix 480 represent the target values for transmission (T), reflection (R), and crosstalk (C). Blank spaces in the s-matrix 480 indicate “don't care” values that are not used as a target value in the loss function Loss(x).

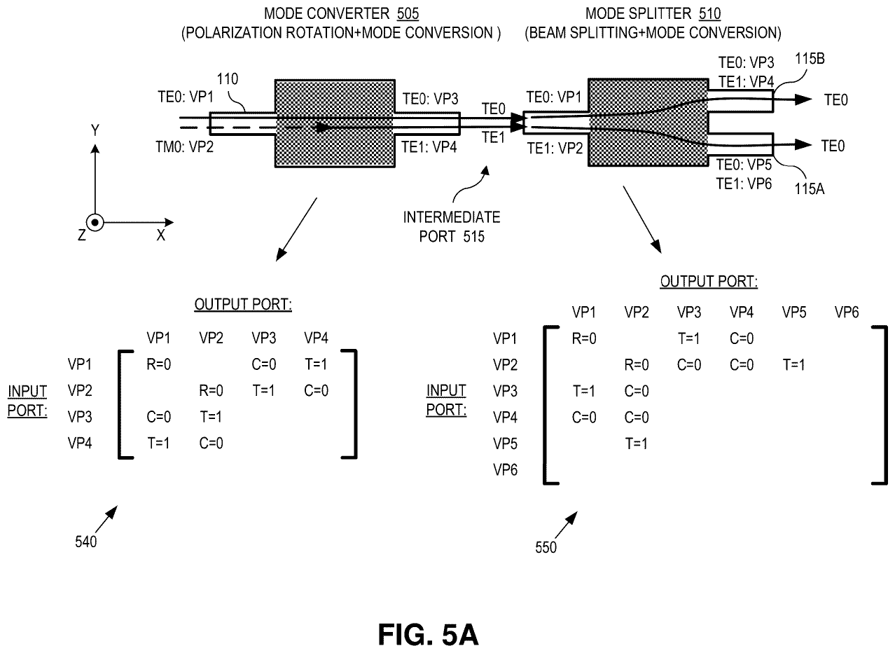

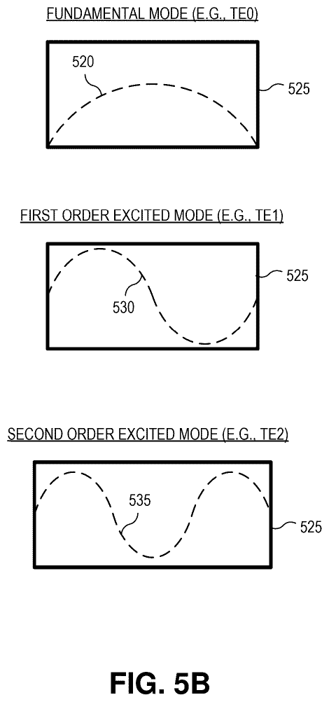

FIG. 5A is a functional block diagram illustrating a PRBS 500 having distinct polarization rotating and beam splitting components linked end-to-end, in accordance with an embodiment. In addition to the polarization rotating and beam splitting functions, PRBS 500 achieves the overall PRBS function by further incorporating a mode conversion into each of its distinct components. Accordingly, the polarization rotating and mode conversion component is referred to as mode converter 505 while the beam splitting and mode conversion component is referred to as mode splitter 510.

Mode conversion is the conversion of optical power propagating in one spatial mode within a waveguide to another spatial mode. FIG. 5B illustrates spatial modes, including a fundamental spatial mode 520 propagating within a planar waveguide 525 and higher order spatial modes 530 or 535 that may also be propagating within planar waveguide 525. The fundamental spatial mode having a TE polarization is referred to as the TE0 mode and the fundamental spatial mode having a TM polarization is referred to as the TM0 mode. Correspondingly, the higher order spatial modes of the TE polarization are referred to as the TE1 mode, TE2 mode, etc. while the higher order spatial modes of the TM polarization are referred to as the TM1 mode, TM2 mode, etc.

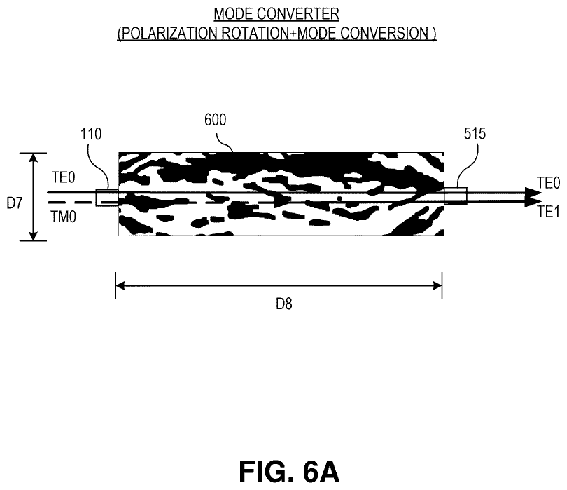

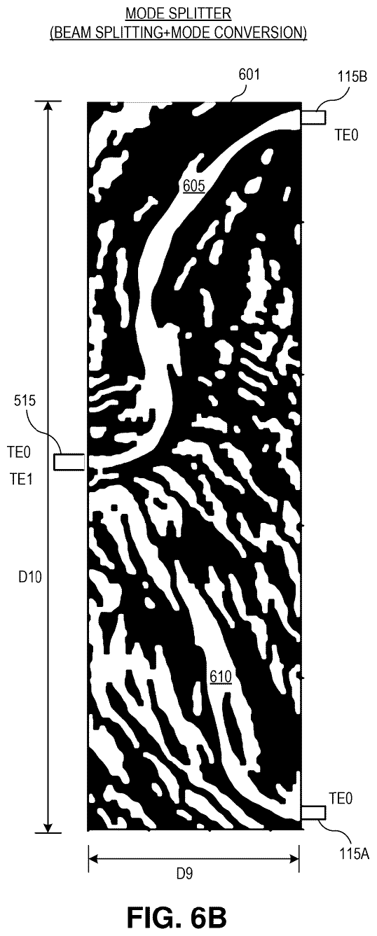

Returning to FIG. 5A, PRBS 500 is one possible implementation of PRBS 100 illustrated in FIG. 1A. PRBS 500 includes a mode converter 505 and mode splitter 510 that collectively implement PRBS region 105 illustrated in FIG. 1A by linking mode converter 505 and mode splitter 510 end-to-end at an intermediate port 515. In one embodiment, mode converter 505 and mode splitter 510 are implemented by distinct irregularly shaped patterns that are both integrated end-to-end into a single planar waveguide (or a pair of end-to-end connected planar waveguides) by optically linking the output of mode converter 505 to the input of mode splitter 510. FIG. 6A illustrates an example inverse designed irregularly shaped pattern for implementing mode converter 505 while FIG. 6B illustrates an example inverse designed irregularly shaped pattern that implements mode splitter 510.

Collectively, mode converter 505 and mode splitter 510 achieve the beam splitting and polarization rotation functions in two distinct patterns/components. Mode converter 505 passes the input TE0 mode to its output at intermediate port 515 without changing its polarization or spatial mode. In contrast, mode converter 505 rotates the polarization and converts the spatial mode of the input TM0 signal. In particular, mode converter 505 rotates the polarization of the input TM0 signal to the TE polarization and upconverts its spatial mode to the TE1 mode.

Mode splitter 510 operates as a beam splitter that splits the optical signal received at intermediate port 515 according to spatial mode. In particular, optical power propagating in the TE0 fundamental spatial mode at intermediate port 515 is directed to output port 115B while optical power propagating in the TE1 higher order spatial mode is directed to output port 115A. However, mode splitter 515 further operates as a mode converter for the higher order spatial modes of the TE polarization. Accordingly, in addition to beam splitting, mode splitter 510 converts the optical power propagating in the higher order spatial mode TE1 received on intermediate port 515 down to the TE0 fundamental spatial mode at output port TE0.

FIG. 5A assigns VP labels to the TE and TM polarizations at each physical port for mode converter 505 and mode splitter 510. For mode converter 505, input port 110 is assigned virtual ports VP1 and VP2 for the TE and TM polarization, respectively, and intermediate port 515 is assigned virtual ports VP3 and VP4 for the TE0 and TE1 spatial modes, respectively. Similarly, for mode splitter 510, intermediate port 515 is assigned virtual ports VP1 and VP2 for spatial modes TE0 and TE1, respectively, output port 115B is assigned virtual ports VP3 and VP4 for the TE0 and TE1 spatial modes, respectively, and output port 115A is assigned virtual ports VP5 and VP6 for the TE0 and TE1 spatial modes, respectively. S-matrix 540 has columns and rows corresponding to the virtual port labels for mode converter 505 while s-matrix 550 has columns and rows corresponding to the virtual port labels for mode splitter 510. The behavior of the inverse designed pattern of mode converter 505 may be described using the s-parameters populated within s-matrix 540 while the behavior of the inverse designed pattern of mode splitter 510 may be described using the s-parameter populated within s-matrix 550. S-matrices 540 and 550 may be referenced to populate the loss function Loss(x) (see above) used to design the patterns of mode converter 505 and mode splitter 510. In particular, the s-parameters represent the target values for transmission (T), reflection (R), and crosstalk (C). Blank spaces in s-matrices 540 and 550 indicate “don't care” values that are not used as a target value in the loss function Loss(x).

FIG. 6A illustrates an irregularly shaped pattern 600 for implementing a mode converter that selectively rotates a TM0 signal to the TE1 mode, in accordance with an embodiment of the disclosure. Pattern 600 represents one possible implementation of mode converter 505. Pattern 600 is an inverse designed irregularly shaped pattern of at least two materials having different refractive indexes (e.g., silicon and silicon oxide). During operation, the input TE0 signal received at input port 110 is passed to intermediate port 515 without changing the polarization or spatial mode of the input TE0 signal. However, pattern 600 is shaped to selectively rotate the polarization of a TM0 signal received at input port 110 to the TE polarization at intermediate port 515 while also converting its spatial mode to the higher order TE1 mode. Pattern 600 is non-symmetrical along both orthogonal axes and includes irregularly shaped features defined by the refractive materials. In one embodiment, pattern 600 has approximate dimensions of D7=7 um and D8=20 um. Of course, other dimensions may be implemented as well. For example, D8 may range between 5-300 um and D7 may range between 2-40 um.

FIG. 6B illustrates an irregularly shaped pattern 601 for implementing a mode splitter that splits a spatial mode to different output ports while also converting the higher order spatial mode to a fundamental spatial mode, in accordance with an embodiment of the disclosure. Pattern 601 represents one possible implementation of mode splitter 510. During operation, pattern 601 is shaped to split the TE0 signal received at intermediate port 515 from the TE1 signal and pass the TE0 signal to output port 115B via channel 605 without changing the polarization or spatial mode of the TE0 signal. Correspondingly, pattern 601 is further shaped to split the TE1 signal from the TE0 signal, direct the TE1 signal to the output port 115A, and convert its spatial mode from the higher order spatial mode to the fundamental spatial mode TE0. In one embodiment, pattern 601 has approximate dimensions of D9=5 um and D10=30 um. Of course, other dimensions may be implemented as well. For example, D9 may range between 5-300 um and D10 may range between 5-300 um.

Pattern 601 is an inverse designed irregularly shaped pattern of at least two materials having different refractive indexes. In one embodiment, these materials include a higher index material (e.g., silicon) and a lower index material (e.g., silicon oxide) arranged into the illustrated pattern. Pattern 601 may be fabricated using conventional semiconductor deposition and etching techniques. Pattern 601 is non-symmetrical along both orthogonal axes and includes irregularly shaped features defined by the refractive materials. The white portions represent the higher refractive index material while the black portions represent the lower refractive index material. Although pattern 601 may assume a variety of different dimensions, in one embodiment, D9 is approximately 7 um and D10 is approximately 24 um.

Pattern 601 includes a number of irregularly shaped features defined by the refractive materials. Many of these features may deviate from the illustrated pattern while achieving nearly similar efficient operation. However, some notable features include an irregularly shaped channel 605 of higher index material extending continuously and circuitously from intermediate port 515 to output port 115B. In contrast, it is also notable that the TE1 to TE0 path from intermediate port 515 to output port 115A does not include a continuous uninterrupted channel of the higher index material extending between the two ports. Rather, output port 115A is connected to a fjord-like feature 610 of the higher index material. Pattern 601 also includes a plurality of other irregularly shaped “islands” of the higher index material disposed within and throughout the lower index material. These irregularly shaped islands are separate and distinct from irregularly shaped channel 605.

The inverse design techniques described above may be applied to determine the specific material combinations, feature sizes, and feature arrangement (i.e., pattern) to achieve the desired polarization rotation, beam splitting, and mode conversion using the above loss function Loss(x). Loss(x) is a function of x, where x is a vector representing the structural pattern of materials having different refractive indexes within the design region.

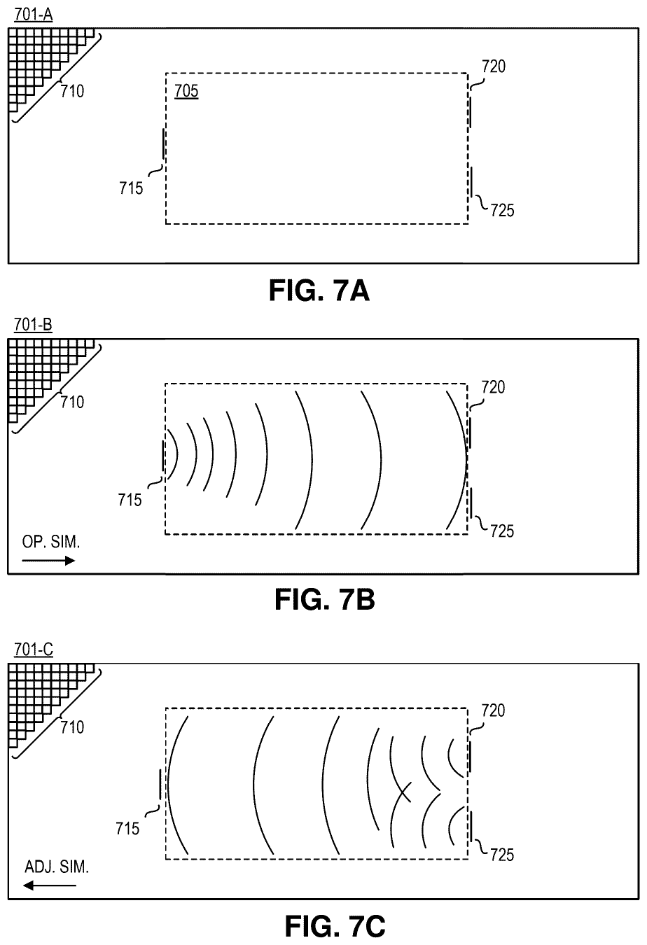

FIGS. 7A-7C illustrate an initial setup, an operational simulation, and an adjoint simulation of a simulated environment 701, respectively, for optimizing structural parameters of a physical device (e.g., PRBS 100, PRBS region 305, pattern 315, pattern 320, PBS 405, PR 410, pattern 420, pattern 470, mode converter 505, mode splitter 510, pattern 600, or pattern 601) with a design model, in accordance with an inverse design embodiment. The simulated environment 701 and corresponding initial setup, operational simulation, adjoint simulation, and structural parameter optimization may be achieved via a physics simulator using Maxwell's equations. As illustrated in FIGS. 7A-7C, the simulated environment is represented in two-dimensions, however it is appreciated that higher dimensionality (e.g., 3-dimensional space) may also be used to describe the simulated environment 701 and the physical device. In some embodiments, the optimization of the structural parameters of the physical device illustrated in FIGS. 7A-7C may be achieved via, inter alia, simulations (e.g., time-forward and backpropagation) that utilize a finite-difference time-domain (FDTD) method to model the field responses (e.g., both electric and magnetic).

FIG. 7A illustrates an example rendering of a simulated environment 701-A describing an electromagnetic device. The simulated environment 701-A represents the simulated environment 701 at an initial time step (e.g., an initial set up) for optimizing structural parameters of the physical device. The physical device described by the simulated environment 701 may correspond to any of the PRBS, PBS, PR, mode converter, or mode splitter described above having a designable region 705 (e.g., irregular shaped pattern) in which the structural parameters of the simulated environment may be designed, modified, or otherwise changed. The simulated environment 701 includes an excitation source 715 (e.g., a gaussian pulse, a wave, a waveguide mode response, and the like) at the location of input port 110. The electrical and magnetic fields (e.g., field response) within the simulated environment 701 may change in response to the excitation source 715. The specific settings of the initial structural parameters, excitation source, performance parameters, and other metrics (i.e., initial description) for a first-principles simulation of a physical device are input before the operational simulation starts.

As illustrated, the simulated environment 701 (and subsequently the physical device under design) is described by a plurality of voxels 710, which represent individual elements of the two-dimensional (or three-dimensional) space of the simulated environment. Each of the voxels is illustrated as two-dimensional squares, however it is appreciated that the voxels may be represented as cubes or other shapes in three-dimensional space. It is appreciated that the specific shape and dimensionality of the plurality of voxels 710 may be adjusted dependent on the simulated environment 701. It is further noted that only a portion of the plurality of voxels 710 are illustrated to avoid obscuring other aspects of the simulated environment 701. Each of the plurality of voxels 710 is associated with one or more structural parameters, a field value to describe a field response, and a source value to describe the excitation source at a specific position within the simulated environment 701. The field response, for example, may correspond to a vector describing the electric and/or magnetic field at a particular time step for each of the plurality of voxels 710. More specifically, the vector may correspond to a Yee lattice that discretizes Maxwell's equations for determining the field response. In some embodiments, the field response is based, at least in part, on the structural parameters and the excitation source 715.

FIG. 7B illustrates an example operational simulation of the simulated environment 701-B at a particular time step in which the excitation source 715 is active (e.g., generating waves originating at the excitation source 715 that propagate through the simulated environment 701). As mentioned, the physical device is an optical modulator operating at the frequency of interest and having a particular waveguide mode (e.g., transverse electromagnetic mode, transverse electric mode, etc.) and the excitation source is at an input port 110. The operational simulation occurs over a plurality of time steps. When performing the operational simulation, changes to the field response (e.g., the field value) for each of the plurality of voxels 710 are updated in response to the excitation source 715 and based, at least in part, on the structural parameters of the physical device at each of the plurality of time steps. Similarly, in some embodiments the source value is updated for each of the plurality of voxels (e.g., in response to the electromagnetic waves from the excitation source 715 propagating through the simulated environment). It is appreciated that the operational simulation is incremental and that the field value (and source value) is updated incrementally at each time step as time moves forward for each of the plurality of time steps. It is further noted that in some embodiments, the update is an iterative process and that the update of each field and source value is based, at least in part, on the previous update of each field and source value.

When performing the operational simulation, the performance loss function, Loss(x), may be computed at each output port 720 and 725 based, at least in part, on a comparison (e.g., mean squared difference) between the field response and a desired field response at a designated time step (e.g. a final time step of the operational simulation). A performance loss value may be described in terms of a specific performance value (e.g., power). Structural parameters may be optimized for this specific performance value.

FIG. 7C illustrates an example backpropagation of performance loss error backwards within the simulated environment 701-C describing the physical device. In one embodiment, the adjoint performance simulation injects a performance loss error at output ports 720 and 725 as a sort of reverse excitation source for stimulating a reverse field response through voxels 710 of simulated environment 701-C. The adjoint performance simulation of the performance loss error determines an influence that changes in the structural parameters of voxels 710 have on the performance loss value.

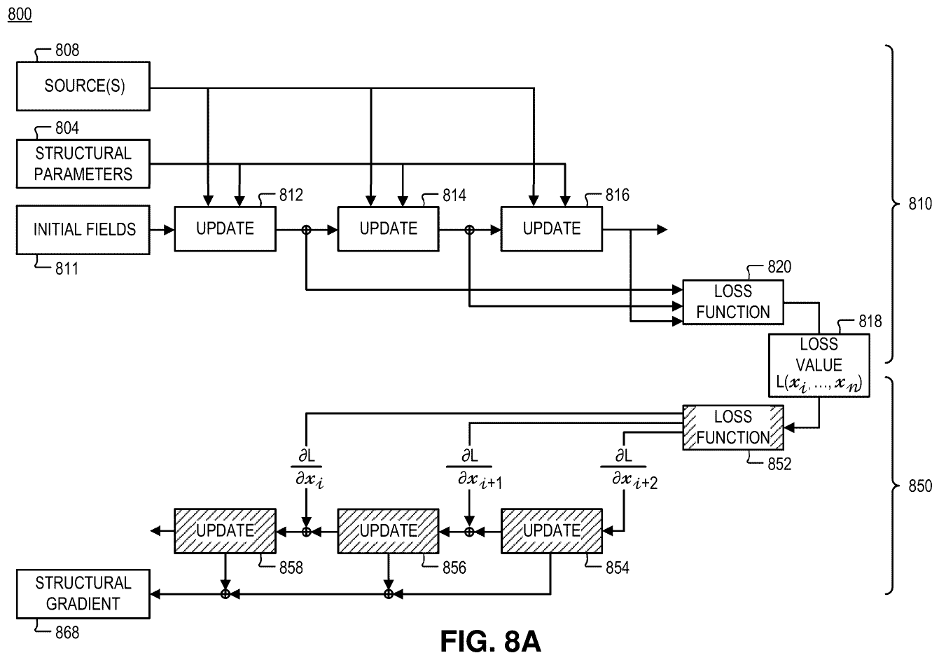

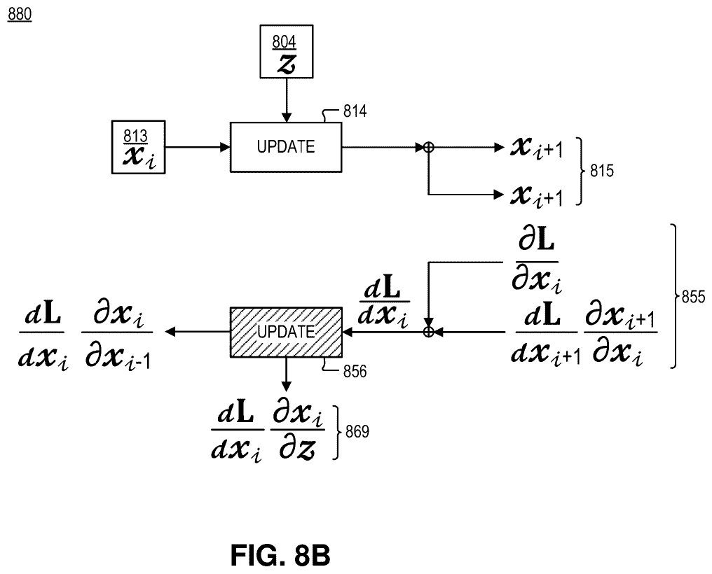

FIG. 8A is a flow chart 800 illustrating example time steps for a time-forward simulation 810 and backpropagation 850 within a simulated environment, in accordance with an embodiment of the present disclosure. Flow chart 800 is one possible implementation that a design model may use to perform a forward operational simulation 810 and backpropagation 850 of a simulated environment. In the illustrated embodiment, the forward operational simulation utilizes a FDTD method to model the field response (both electric and magnetic) at a plurality of time steps in response to an excitation source. More specifically, the time-dependent Maxwell's equations (in partial differential form) are discretized to solve for field vector components (e.g. the field response of each of the plurality of voxels 710 of the simulated environment 701 in FIGS. 7A-7C) over a plurality of time steps.

As illustrated in FIG. 8A, the flow chart 800 includes update operations for a portion of operational simulation 810 and adjoint simulation 850. Operational simulation 810 occurs over a plurality of time-steps (e.g., from an initial time step to a final time step over a pre-determined or conditional number of time steps having a specified time step size) and models changes (e.g., from the initial field values 811) in electric and magnetic fields of a plurality of voxels describing the simulated environment and/or physical device that collectively correspond to the field response. More specifically, update operations (e.g., 812, 814, and 816) are iterative and based on the field response, structural parameters 804, and one or more physical stimuli sources 808. Each update operation is succeeded by another update operation, which are representative of successive steps forward in time within the plurality of time steps. For example, update operation 814 updates the field values 813 (see, e.g., FIG. 7B) based on the field response determined from the previous update operation 812, sources 808, and the structural parameters 804. Similarly, update operation 816 updates the field values (see, e.g., FIG. 8B) based on the field response determined from update operation 814. In other words, at each time step of the operational simulation the field values (and thus field response) are updated based on the previous field response and structural parameters of the physical device. Once the final time step of the operational simulation 810 is performed, the loss value 818 may be determined (e.g., based on a pre-determined loss function 820). The loss gradients determined from block 852 may be treated as adjoint or virtual sources (e.g., physical stimuli or excitation source originating at an output region) which are backpropagated in reverse (from the final time step incrementally through the plurality of time steps until reaching the initial time step) to determine structural gradient 868.

In the illustrated embodiment, the FDTD solve (e.g., time-forward simulation 810) and backpropagation 850 problem are described pictorially, from a high-level, using only “update” and “loss” operations as well as their corresponding gradient operations. The simulation is set up initially in which the structure parameters, the excitation source, and the initial field states of the simulated environment (and electromagnetic device) are provided. As discussed previously, the field states are updated in response to the excitation source based on the structural parameters. More specifically, the update operation is given by ϕ, where [symbol] =ϕ( [symbol] , [symbol] , [symbol] ) for [symbol] =1, . . . [symbol] . Here, [symbol] corresponds to the total number of time steps (e.g., the plurality of time steps) for the time-forward simulation, [symbol] corresponds to the field response (the field value associated with the electric and magnetic fields of each of the plurality of voxels) of the simulated environment at time step [symbol] , [symbol] corresponds to the excitation source(s) (the source value associated with the electric and magnetic fields for each of the plurality of voxels) of the simulated environment at me step [symbol] , and [symbol] corresponds to the structural parameters describing the topology and/or material properties of the electromagnetic device.

It is noted that using the FDTD method, the update operation can specifically be stated as:

$$ϕ ( {x}_{i} , {b}_{i} , z ) = A ( z ) {x}_{i} + B ( z ) {b}_{i} . \qquad ( 1 )$$

That is to say the FDTD update is linear with respect to the field and source terms. Concretely, A( [symbol] )∈ [symbol] ^{N×N} and B( [symbol] )∈ [symbol] ^{N×N} are linear operators which depend on the structure parameters, [symbol] and act on the fields, [symbol] , and the sources, [symbol] , respectively. Here, it is assumed that [symbol] , [symbol] ∈ [symbol] ^{N} where N is the number of FDTD field components in the time-forward simulation. Additionally, the loss operation is given by L=( [symbol] , . . . , [symbol] ), which takes as input the computed fields and produces a single, real-valued scalar (e.g., the loss value) that can be reduced and/or minimized.

In terms of revising or otherwise optimizing the structural parameters of the electromagnetic device, the relevant quantity to produce is [symbol] , which is used to describe the change in the loss value with respect to a change in the structural parameters of the electromagnetic device and is denoted as the “structural gradient” illustrated in FIG. 8A.

FIG. 8B is a chart 880 illustrating the relationship between the update operation for the operational simulation and the adjoint simulation (e.g., backpropagation), in accordance with an embodiment of the present disclosure. More specifically, FIG. 8B summarizes the operational and adjoint simulation relationships that are involved in computing the structural gradient, [symbol] , which include [symbol] ,

$$\frac{\partial {x}_{i + 1}}{\partial {x}_{i}} ,$$

[symbol]

and [symbol] . The update operation 814 of the operational simulation updates the field values 813, [symbol] of the plurality of voxels at the [symbol] th time step to the next time step (i.e., [symbol] +1 time step), which correspond to the field values 815, [symbol] . The gradients 855 are utilized to determine [symbol] for the backpropagation (e.g., update operation 856 backwards in time), which combined with the gradients 869 are used, at least in part, to calculate the structural gradient, [symbol] , [symbol] is the contribution of each field to the loss value, L. It is noted that this is the partial derivative, and therefore does not take into account the causal relationship of

$${x}_{i} \to {x}_{i + 1} .$$

### Thus,

$$\frac{\partial {x}_{i + 1}}{\partial {x}_{i}}$$

is utilized which encompasses the

$${x}_{i} \to {x}_{i + 1}$$

relationship. The loss gradient, [symbol] may also be used to compute the structural gradient, [symbol] , and corresponds to the total derivative of the field with respect to loss value, L. The loss gradient, [symbol] , at a particular time step, [symbol] , is equal to the summation of

$$\frac{\partial L}{\partial {x}_{i}} + \frac{dL}{{dx}_{i + 1}} \frac{\partial {x}_{i + 1}}{\partial {x}_{i}} .$$

Finally, [symbol] , corresponds to the field gradient, is used which is the contribution to [symbol] from each time/update step. [symbol] is given by:

$$\frac{dL}{dz} = {\sum }_{i} \frac{dL}{{dx}_{i}} \frac{\partial {x}_{i}}{\partial z} . \qquad ( 2 )$$

For completeness, the full form of the first time in the sum, [symbol] , is expressed as:

$$\frac{dL}{{dx}_{i}} = \frac{\partial L}{\partial {x}_{i}} + \frac{dL}{{dx}_{i + 1}} \frac{\partial {x}_{i + 1}}{\partial {x}_{i}} . \qquad ( 3 )$$

Based on the definition of ϕ as described by equation (1), it is noted that

$$\frac{\partial {x}_{i + 1}}{\partial {x}_{i}} = A ( z ) ,$$

which can be substituted in equation (3) to arrive at an adjoint update for backpropagation (e.g., the update operations such as update operation 856), which can be expressed as:

$$\frac{dL}{{dx}_{i}} = \frac{\partial L}{\partial {x}_{i}} + \frac{dL}{{dx}_{i + 1}} A ( z ) , \qquad ( 4 )$$

$$or$$

$${∇}_{{x}_{i}} L = {A ( z )}^{T} {∇}_{{x}_{i + 1}} L + \frac{\partial {L}^{T}}{\partial {x}_{i}} . \qquad ( 5 )$$

The adjoint update is the backpropagation of the loss gradients from later to earlier time steps and may be referred to as a backwards solve for [symbol] . The second term in the sum of the structural gradient, [symbol] , is denoted as:

$$\frac{\partial {x}_{i}}{\partial z} = \frac{d ϕ ( {x}_{i - 1} \cdot {b}_{i - 1} , z )}{dz} = \frac{dA ( z )}{dz} {x}_{i - 1} + \frac{dB ( z )}{dz} {b}_{i - 1} , \qquad ( 6 )$$

for the particular form of ϕ described by equation (1).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A polarization rotating and beam splitting (PRBS) photonic device, comprising:
a planar waveguide disposed in or on a multi-layer semiconductor stack, the planar waveguide having an input port and output ports;
a polarization rotating component integrated into the planar waveguide, wherein the polarization rotating component includes a first irregular pattern of at least two materials having different refractive indexes, the first irregular pattern shaped to rotate at least a portion of an optical signal received via the input port from a transverse magnetic (TM) polarization to a transverse electric (TE) polarization; and
a beam splitting component integrated into the planar waveguide, wherein the beam splitting component includes a second irregular pattern of the at least two materials shaped to split the optical signal between the output ports,
wherein the first and second irregularly shaped patterns are optically coupled and collectively shaped to receive input TE and TM signals multiplexed on the optical signal at the input port of the planar waveguide and generate output TE signals demultiplexed on the output ports.

2. The PRBS photonic device of claim 1, further comprising:
a material layer disposed within the multi-layer semiconductor stack and extending along at least a portion of the polarization rotating component to break a symmetry of the multi-layer semiconductor stack in a vicinity of the planar waveguide to encourage polarization rotation between the TM and TE polarizations within the polarization rotating component, wherein the material layer is physically offset from the planar waveguide and is a distinct material from the at least two materials.

3. The PRBS photonic device of claim 2, wherein the at least two materials comprise silicon and silicon dioxide and the material layer comprises silicon nitride or polysilicon.

4. The PRBS of claim 2, wherein the material layer comprises a passivation layer of the multi-layer semiconductor stack or the material layer comprises a buried channel waveguide having a first center that is laterally offset from a second center of the planar waveguide.

5. The PRBS of claim 1, wherein the planar waveguide comprises one of a rib waveguide, a ridge waveguide, a slab waveguide, or a buried channel waveguide.

6. The PRBS of claim 5, wherein the planar waveguide comprises either a rib waveguide or a ridge waveguide and the first and second irregular patterns are disposed within a rib portion of the rib waveguide or a ridge portion of the ridge waveguide.

7. The PRBS of claim 1, wherein the first and second irregular patterns are inverse designed patterns formed from silicon and silicon dioxide disposed within the planar waveguide, wherein the first and second irregular patterns are optically coupled end-to-end within the planar waveguide, and wherein the multi-layer semiconductor stack comprises a photonic integrated circuit (PIC).

8. The PRBS of claim 1, wherein the polarization rotating and beam splitting components are integrated together as a common component and the first and second irregular patterns form a single combined pattern sharing a common overlapping area within the planar waveguide.

9. The PRBS of claim 1, wherein the beam splitting component comprises a polarization beam splitter (PBS) and the second irregular pattern is shaped to demultiplex the input TE and TM signals by directing a first power majority of the input TE signal received at the input port to a first one of the output ports via asymmetrical power splitting while directing a second power majority of the input TM signal received at the input port to an intermediate port between the beam splitter component and the polarization rotating component via multipath interferometry.

10. The PRBS of claim 9, wherein the second irregular pattern comprises a first irregular shaped channel of a higher refractive index material surrounded by a lower refractive index material, the first irregular shaped channel extending between the input port and the first one of the output ports.

11. The PRBS of claim 9, wherein the second irregularly shaped pattern is shaped to selectively guide the second power majority of the input TM signal from the input port to the intermediate port via a plurality of TM paths extending from the input port to the intermediate port, the TM paths each defined by a higher refractive index material surrounded by a lower refractive index material.

12. The PRBS of claim of claim 9, wherein the polarization rotating component includes a polarization rotating input aligned with the intermediate port and a polarization rotating output aligned with a second one of the output ports, wherein the first irregular pattern includes a higher refractive index material surrounded by a lower refractive index material and does not include a continues uninterrupted channel of the higher refractive index material extending between the polarization rotating input and output.

13. The PRBS of claim 1, wherein the polarization rotating component comprises a mode converter and the first irregular pattern is shaped to both rotate the input TM signal to the TE polarization at an intermediate port disposed between the polarization rotating and beam splitter components and also shaped to convert a fundamental spatial mode of the input TM signal to a higher order TE spatial mode at the intermediate port.

14. The PRBS of claim 1, wherein the beam splitting component comprises a mode splitter and the second irregular pattern is shaped to both split the optical signal received at an intermediate port disposed between the polarization rotating and beam splitting components to the output ports and to convert the portion of the optical signal rotated by the polarization rotating component from a higher order TE spatial mode at the intermediate port to one of the output TE signals in a fundamental TE spatial mode at one of the output ports.

15. The PRBS of claim 14, wherein the second irregular pattern of the mode splitter includes a first irregularly shaped channel of a higher refractive index material surrounded by a lower refractive index material that extends continuously and circuitously from the intermediate port to a first one of the output ports and does not include a continuous channel of the higher index material extending between the intermediate port and a second one of the output ports.

16. The PRBS of claim 1, wherein at least one of the first or second irregular patterns comprises a three-dimensional pattern that extends across and is defined by multiple layers of the multi-layer semiconductor stack.

17. A polarization rotating and beam splitting (PRBS) photonic device, comprising:
a planar waveguide disposed in or on a multi-layer semiconductor stack, the planar waveguide having an input port and output ports;
an inverse designed irregular pattern of at least two materials having different refractive indexes, the inverse designed irregular pattern shaped to rotate at least a portion of an optical signal received via the input port from a transverse magnetic (TM) polarization to a transverse electric (TE) polarization and further shaped to split the optical signal between the output ports,
wherein the inverse designed irregular pattern is further shaped to receive input TE and TM signals multiplexed on the optical signal at the input port of the planar waveguide and generate output TE signals demultiplexed on the output ports.

18. The PRBS of claim 17, wherein the planar waveguide comprises either a rib waveguide or a ridge waveguide and the inverse designed irregular pattern is disposed within a rib portion of the rib waveguide or a ridge portion of the ridge waveguide.

19. The PRBS photonic device of claim 18, further comprising:
a material layer disposed within the multi-layer semiconductor stack and extending along at least a portion of the inverse designed irregular pattern to break a symmetry of the multi-layer semiconductor stack in a vicinity of the planar waveguide to encourage polarization rotation between the TM and TE polarizations, wherein the material layer is physically offset from the planar waveguide and is a distinct material from the at least two materials.

20. The PRBS photonic device of claim 19, wherein the at least two materials comprise silicon and silicon dioxide and the material layer comprises silicon nitride.

21. The PRBS photonic device of claim 17, wherein the inversed design irregular pattern is shaped to demultiplex the TE and TM signals by directing a first power majority of the TE signal received at the input port to a first one of the output ports via asymmetrical power splitting while directing a second power majority of the TM signal received at the input port to a second one of the output ports via multipath interferometry.
